(19) United States
(12) Patent Application Publication
(10) Pub. No.: US 2022/0144612 A1
(43) Pub. Date: May 12, 2022

(54) ELECTRIC LIFTING TYPE AERIAL WORK PLATFORM

(71) Applicant: ZHEJIANG DINGLI MACHINERY CO., LTD., Huzhou (CN)

(72) Inventors: Shugen Xu, Huzhou (CN); Zhong Xu, Huzhou (CN)

(21) Appl. No.: 17/146,858

(22) Filed: Jan. 12, 2021

(30) Foreign Application Priority Data
Nov. 6, 2020 (CN) 2020112293066

(51) Int. Cl. B66F 11/04; B60L 50/60; B66F 13/00

(52) U.S. Cl. CPC B66F 11/04; B60L 2200/40; B66F 13/00; B60L 50/66

(57) ABSTRACT

The present disclosure provides an electric lifting type aerial work platform. A column is fixed on a platform support and can move with the platform support; a workbench is connected with the column, the workbench can be lifted, and carries operators; a drive mechanism drives the column to lift. The column includes at least three sleeves sleeved in sequence, and the workbench is connected with the outer sleeve. The driving mechanism includes a first motor, a reducer, a brake and a first push rod; the first motor drives the outer sleeve to move via the push rod. Each of the sleeve is provided with a roller provided with a chain, and both ends of the chain are connected to two sleeves that are respectively located outside and inside of the sleeve where the roller corresponding to the chain is provided.

### TECHNICAL FIELD

The present disclosure relates to the technical field of aerial work platforms, and in particular, to an electric lifting type aerial work platform.

### BACKGROUND

Aerial work platform has been a product that serves mobile aerial works such as aerial works, equipment installation and maintenance in various industries. The related products of aerial work platform mainly include the following six categories: scissor aerial work platform, vehicle-mounted aerial work platform, crank arm aerial work platform, self-propelled aerial work platform, aluminum alloy aerial work platform, and cylinder-type aerial work platform. Most of them use engines or hydraulic methods to provide power for the lifting mechanisms to lift the working platforms, which generally suffer from problems such as loud noise, serious exhaust gas pollution, easy oil leakage, and inconvenient maintenance. Especially for the lifting trolleys that are used more in indoor spaces or outside buildings, they are more sensitive to various forms of pollution that may occur during the lifting process.

### SUMMARY

The present disclosure provides an electric lifting type aerial work platform, in which pure electric drive is adopted to move the lifting platform and run the trolley. It is safe and environmentally friendly with low noise, and it is more suitable for indoor operations, and can meet the needs of social energy saving and emission reduction. The lifting structure thereof has high stability with compact structure, and requirements for installation space are low.

In order to achieve the purpose, the present disclosure adopts the following technical solutions:

An electric lifting type aerial work platform, wherein, may include:
a column, the column may be fixed on a platform support and can extend and retract up and down relative to the platform support;
a workbench, the workbench may be connected to the column, the workbench may be capable to lift with the column, and carry operators;
a driving mechanism, the driving mechanism may drive the column to lift up and down;
the column may include at least three sleeves sleeved in sequence, and the workbench may be connected with an outer sleeve;
the driving mechanism may include a first motor, a reducer, a brake, and a first push rod. The first motor may drive the outer sleeve to move via the push rod. The sleeve may be provided with a roller, and the roller may be provided with a chain; and the two ends of the chain may be connected to two sleeves that are respectively located outside and inside of the sleeve where the roller corresponding to the chain is provided.

The drive approach of electric push rod in conjunction with the chain is adopted to make the synchronous lifting of the sleeve achieved, avoiding maintenance costs and environmental problems caused by the engine or hydraulic drive; the structure form integrated from the reducer, the brake and the motor is adopted, such that the first motor is directly braked, to reduce the requirements for the space layout of the trolley.

As a preference, the sleeves at the lower side may be sequentially inserted into the sleeves at the upper side, vertical plates may be provided on the side wall of the sleeves, and the roller may be rotatably connected to the vertical plates; one end of the chain may be connected with a sleeve outside the sleeve where the roller corresponding to the chain is arranged, and the other end may be connected to the vertical plate.

The upper sleeves are sleeved with the lower sleeves, such that the external workbench is convenient for setting up, and the space required for installing the column may be small.

As a preference, the number of the vertical plates on the sleeves may be two or three, the vertical plates may be parallel to each other, a rotating shaft may be arranged between the vertical plates, and the rotating shaft may be provided with two of the chains symmetrically.

This arrangement can ensure the linearity of the drive sleeve during extending and retracting, the occurrence of the sleeve tilting and jamming may be avoided.

As a preference, the push rod may be connected to the sleeve located in the middle layer.

As a preference, the workbench may include a bottom plate and a guard plate extending upward from the bottom plate, the guard plate may be provided with a vertical rod, the vertical rod may be provided with a cross beam, and the outer sleeve may be provided with an upper connecting piece and a lower connecting piece, the lower connecting piece may be connected with the guard plate, and the cross beam may be set on the upper connecting piece, to ensure the stability of the connection structure of the workbench and avoid excessive stress on the sleeve.

As a preference, the workbench may include a bottom plate, the bottom plate may include a lower plate and an upper plate that are capable to move relative to each other; the upper plate may be provided with an inner plate, the lower plate may be provided with an outer plate; and the outer plate may be provided with a limit groove, the inner plate may be provided with a limit mechanism; the limit mechanism may include a base, and a hinge piece rotating relative to the base along a horizontal rotation axis, the hinge piece may be provided with a limit piece, and the hinge piece is capable to make the limit piece to move with respect to the limit groove.

Thus, the length of the workbench can be extended to expand its use range, and the setting of the limit structure ensures the stability of its structure.

As a preference, the inner plate may be provided with two frames opposite to each other, each of the two frames may be respectively provided with a door that can be opened by opposite sides, and the door may be provided with a manual controller.

As a preference, a trolley may be provided at the lower side of the column, the trolley may be provided with a second motor, two driving wheels and two walking wheels rotatable relative to the trolley, and the two walking wheels may be connected by a connecting rod, the output end of the second motor may be provided with a second push rod, the second push rod may be hinged with the connecting rod, and the second motor drives the walking wheels to rotate synchronously to realize steering.

As a preference, a battery may be provided in the trolley, and the battery may be located in the middle position of the first motor and the second motor, which can improve the stability of the trolley.

In summary, compared with the prior art, the advantages of the present disclosure are: pure electric drive is adopted to move the lifting platform and run the trolley. It is safe and environmentally friendly with low noise, and it is more suitable for indoor operations, and can meet the needs of social energy saving and emission reduction. The lifting structure thereof has high stability with compact structure, and requirements for installation space are low.

### BRIEF DESCRIPTION OF THE DRAWINGS

FIG. 1 is a schematic diagram of the structure of the present disclosure;

FIG. 2 is an enlarged view of part A in FIG. 1;

FIG. 3 is a front view of the structure of the present disclosure;

FIG. 4 is a side view of the structure of the present disclosure;

FIG. 5 is a sectional view of the lifting mechanism of the present disclosure;

FIG. 6 is an another sectional view of the lifting mechanism of the present disclosure.

The reference numerals in the figures are listed as follows: 1—column, 11—sleeve, 111—outer sleeve, 112—first sleeve, 113—second sleeve, 114—third sleeve, 115—inner sleeve, 12—upper connecting piece, 13—lower connecting piece, 2—platform support, 3—workbench, 31 bottom plate, 32 guard plate, 33—vertical rod, 34—cross beam, 35—upper plate, 36—lower plate, 37—inner plate, 371—frame, 372—door, 373—manual controller, 38—outer plate, 381—limit groove, 4—driving mechanism, 41—first motor, 42—first push rod, 43—roller, 44—chain, 45—vertical plate, 451—rotating shaft, 46—first screw, 5—limit mechanism, 51—base, 52—hinge piece, 53—limit piece, 6—trolley, 61—walking wheel, 62—connecting rod, 63—second motor, 64—second push rod, 65—side plate, 66—top plate, 67—baffle, 68—driving wheel.

### DETAILED DESCRIPTION OF THE EMBODIMENT

The present disclosure will be further described below in combination with the embodiments in the drawings.

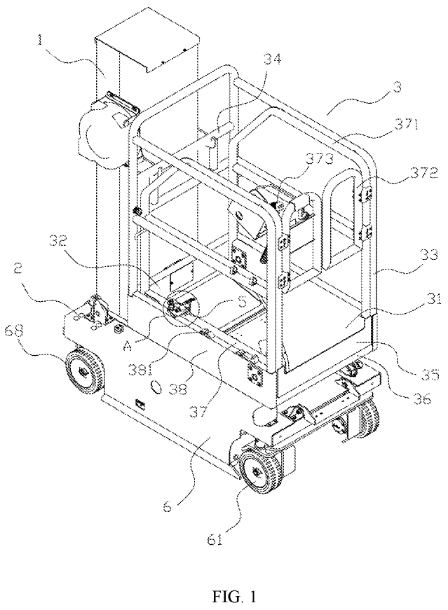

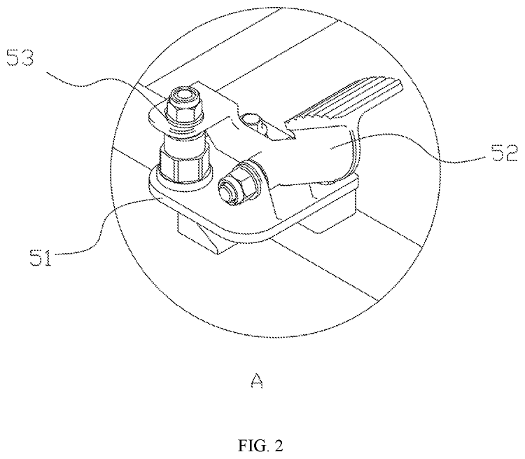

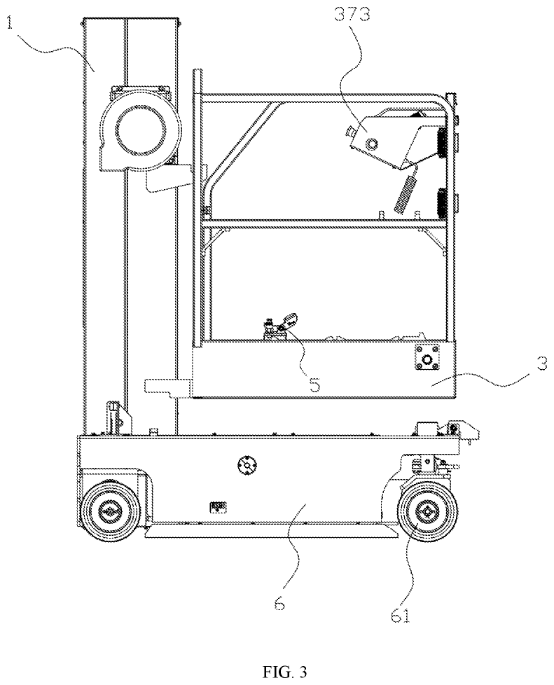

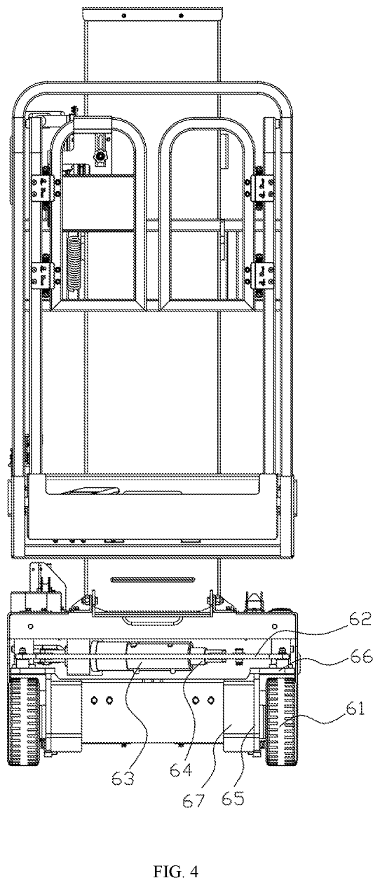

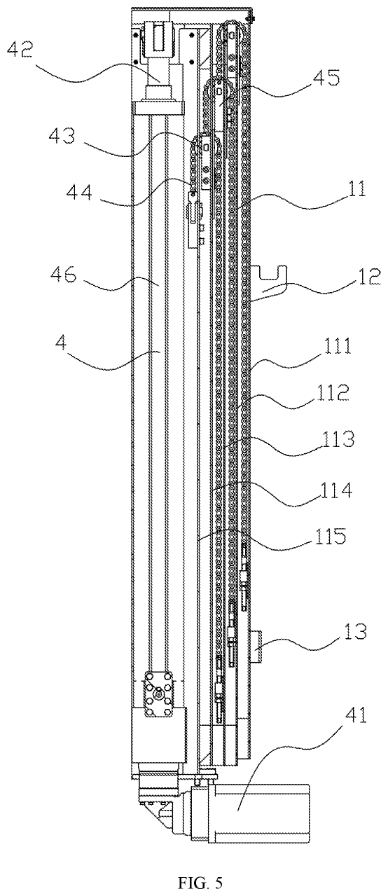

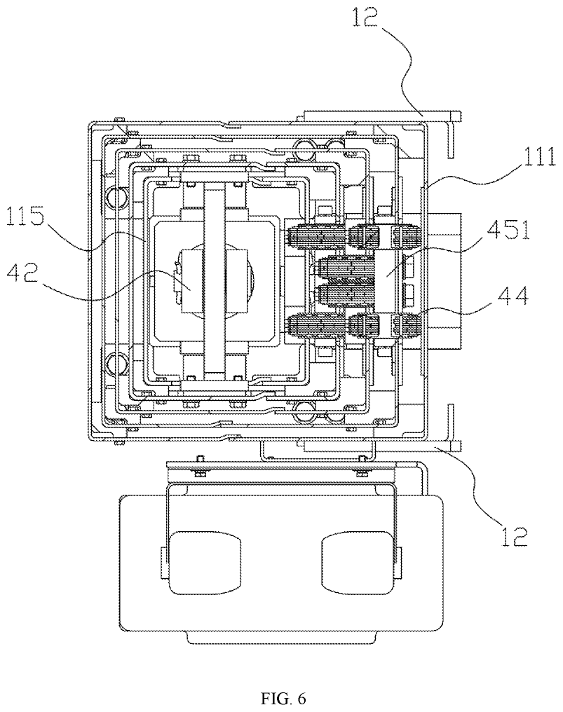

As shown in FIG. 1 to FIG. 6, in the present electric lifting type aerial work platform, the column 1 may be fixed on the platform support 2 and can be extended upwards vertically, the workbench 3 may be connected with the column 1, and the workbench 3 can go down under the action of the column 1, and carry the operators. The driving mechanism 4 may drive the column 1 to extend and retract. The column 1 may include four sleeves 11 sleeved in sequence, that is, from the outside to the inside, an outer sleeve 111, a first sleeve 112, a second sleeve 113, a third sleeve 114 and an inner sleeve 115, and the workbench 3 may be connected with the outer sleeve 111. The driving mechanism 4 may include a first motor 41, a reducer, a brake, and a first push rod 42. The first motor 41 may drive the third sleeve 114 to move up and down via the first push rod 42. Each of the first sleeve 112, the second sleeve 113 and the third sleeve 114 may be provided with a roller 43, and each roller 43 may be provided with a chain 44. The two ends of the chain 44 may be connected to two sleeves that are respectively located outside and inside of the sleeve 11 where the roller 43 corresponding to the chain 44 is provided, that is, the two ends of the chain on the roller on the first sleeve 112 may be respectively connected to the outer sleeve 111 and the second sleeve 113, and the two ends of the chain on the roller on the second sleeve 113 may be respectively connected to the first sleeve 112 and the third sleeve 114, and the two ends of the chain on the roller on the third sleeve 114 may be connected to the second sleeve 113 and the inner sleeve 115 respectively. The upper end of the first push rod 42 may be connected with the third sleeve 114 and can push the third sleeve 114 to move up. At this time, the third sleeve 114 may drive the second sleeve 113 to move through the chain. The inner sleeve 115 may be fixed relative to the first motor 41, which cooperates with the first screw 46 to form a stable foundation for the telescopic sleeve. The second sleeve 113 and the first sleeve 112 move up while driving the outside sleeve to move, that is, to realize the synchronous movement of the sleeves. When the first push rod 42 drives the second sleeve 113 to move down, it and the sleeve will descend at a uniform speed under the action of gravity.

The drive approach of electric push rod in conjunction with the chain 44 is adopted to make the synchronous lifting of the sleeves 11 achieved, avoiding maintenance costs and environmental problems caused by the engine or hydraulic drive. The structure form integrated from the reducer, the brake and the motor is adopted, such that the first motor 41 is directly braked, to reduce the requirements for the space layout of the trolley.

The side walls of the first sleeve 112, the second sleeve 113 and the third sleeve 114 may be provided with vertical plates 45, and the roller 43 may be rotatably connected to each of the vertical plates 45. One end of the chain 44 may be connected to the sleeve outside the sleeve where the roller 43 is arranged, and the other end may be connected to the vertical plate 45. The chain 44 may pass through the side wall of the sleeve on one side and extend downward to the lower end of the sleeve outside. The other end of the chain 44 may pass through the side wall of the sleeve on the inner side and extend downward to the vertical plate 45, and may be connected to the connecting shaft between the two vertical plates 45. The outer sleeve 111, the first sleeve 112, the second sleeve 113, the third sleeve 114 and the inner sleeve 115 may be sequentially sleeved, which reduces the space required for installing the column 1. When the first sleeve 112 moves upward, the outer sleeve 111 may be driven to move, and the position of the outer sleeve 111 relative to the first sleeve 112 may be fixed and always sleeved outside the first sleeve 112 to ensure the stability of the installation structure of the workbench.

In this embodiment, the number of vertical plates 45 on the first sleeve 112, the second sleeve 113 and the third sleeve 114 may be two, and the two vertical plates 45 on a single sleeve may be mutually parallel, and a rotating shaft 451 may be provided between the two vertical plates 45. Two chains 44 may be symmetrically arranged on the rotating shaft 451. The two chains 44 may be arranged symmetrically with respect to the push rod, to ensure the linearity of the sleeve 11 during the extending and retracting process when driven, and to avoid the situation that the sleeve is tilted and jammed.

The workbench 3 may include a bottom plate 31 and a guard plate 32 extending upward from the bottom plate 31. The guard plate 32 may be provided with a vertical rod 33, the vertical rod 33 may be provided with a cross beam 34. The outer sleeve 111 may be provided with at least one upper connecting piece 12 and at least one lower connecting piece 13, the lower connecting piece 13 may be connected with the guard plate 32, the cross beam 34 may be set on the upper connecting piece 12. The number of the upper connecting pieces 12 and the lower connecting pieces 13 may be both two, and they may be arranged horizontally on both sides of the outer sleeve 111, so as to ensure the stability of the connection structure of the workbench 3, the local stress of the sleeve 11 may be prevented from being too large.

The workbench 3 may include a bottom plate 31. The bottom plate 31 may include a lower plate 36 and an upper plate 35 that are capable to move relative to each other. The upper plate 35 may be provided with an inner plate 37, the lower plate 36 may be provided with an outer plate 38, and the outer plate 38 may be provided with a limit groove 381. The inner plate 37 may be provided with a limit mechanism 5. The limit mechanism 5 may include a base 51 fixed on the upper end of the inner plate 37, and a hinge piece 52 that can rotate relative to the base 51 along a horizontal shaft. The end of the hinge piece 52 may be provided with a limit piece 53 and the hinge piece 52 can be rotated, such that the fitting and loosening of the limit piece 53 and the limit groove 381 can be realized. The upper plate 35 can move in a horizontal direction relative to the lower plate 36 to form a telescopic structure, so the length of the workbench 3 can be extended. The limit groove 381 may be a groove body between the protrusions on the outer plate 38, and three limit grooves 381 may be provided along the outer plate 38. The outer side plate 38 may be a sheet metal part, the upper edge thereof may be bent inward and downward to form a track groove, and the inner plate 37 may be provided with a sliding block that cooperates with the track groove. The upper edge of the inner plate 37 may be bent outwards and downwards to form a track groove, and the outer plate 38 may be provided with a sliding block that cooperates with the track groove. As a result, the length of the workbench 3 can be extended to expand its use range, and the setting of the limit structure ensures the stability of the structure and avoids relative movement between the upper plate and the lower plate during the working process.

The two sides of the inner plate 37 may be provided with frames 371 opposite to each other. Each of the frame 371 may be a U-shaped frame structure with an opening facing down, such that the safety of aerial workers can be ensured. The two frames 371 may be respectively provided with a door 372 that can be opened by opposite sides. The door 372 may be hinged on the frame 371 through hinges, and the door may be equipped with a manual controller 373, so the platform can be controlled on the workbench, and the operator can control it without moving to the side of the column.

The platform support 2 may be arranged on the trolley 6. The trolley 6 may be provided with a second motor 63, two driving wheels 68 and two walking wheels 61 that can rotate relative to the trolley 6. The driving wheel 68 may be located on the side close to the column 1 relative to the driven wheel 61. The driving wheel 68 may be driven by a rim motor, and the walking wheel 61 can also be provided with a rim motor as needed. The two walking wheels 61 may be connected by a connecting rod 62. The output end of the second motor 63 may be provided with a second push rod 64. The second push rod 64 may be hinged on the walking wheel close to one side of the connecting rod 62, and a certain angle may be exist between the second push rod and the connecting rod. The second push rod 64 may be driven by the second motor 63 to extend and retract, and a moment can be given to the connecting rod to realize the synchronous rotation of the walking wheel 61, such that the steering can be made. The walking wheel 61 may be arranged at the lower end of the trolley 6, the side part of the walking wheel 61 may be provided with a side plate 65, the upper part may be provided with a top plate 66. The end of the connecting rod 62 may be set on the top plate 66, and the side plate can be provided with a rim motor driving the walking wheel 61 to rotate. The side of the rim motor may be also provided with an arc-shaped baffle 67.

The trolley 6 may be provided with a battery. The battery may be located in the middle of the first motor 41 and the second motor 63 to supply power to the motor. The battery is located in the middle area of the trolley 6, which can improve the stability of the trolley 6. The lower end of the column 1 may be provided with two bearing platforms, the inner sleeve 115 may be fixed on the bearing platforms, the driving mechanism 4 may be arranged between the two bearing platforms. The reducer and brake may be horizontally arranged on both sides of the first motor 41, and the output end of the reducer may extend upward in the vertical direction and may drive the first screw to rotate. The first motor 41 may drive the first screw 46 to rotate, and then drive the first push rod 42 on the first screw 46 to move up and down.

The above description may be only an explanation of the present disclosure, so that a person of ordinary skill in the art can implement the solution completely, but it is not a limitation for the present disclosure. After reading this description, those skilled in the art can make any modifications that have no creative contribution as needed for this embodiment. Those are not creative modifications, but they are protected by the patent law as long as they fall within the scope of the claims of the present disclosure.

1. An electric lifting type aerial work platform, wherein comprising:
a column, said column being fixed on a platform support and extended and retracted up and down relative to the platform support;
a workbench, the workbench being connected to the column, the workbench being capable to lift with the column, and carry operators;
a driving mechanism, the driving mechanism driving the column to lift up and down;
the column comprising at least three sleeves sleeved in sequence, and the workbench being connected with an outer sleeve;
the driving mechanism comprising a first motor, a reducer, a brake, and a first push rod; the first motor driving the outer sleeve to move via the first push rod, each of the sleeves being provided with a roller, the roller being provided with a chain, and two ends of the chain being connected to two sleeves that are respectively located outside and inside of the sleeve where the roller corresponding to the chain is provided.

2. The electric lifting type aerial work platform according to claim 1, wherein: the sleeves at a lower side are inserted into the sleeves at an upper side in sequence, and the sleeve is provided with vertical plates on a side wall; the vertical plates are rotatably connected to the roller; one end of the chain is connected to the sleeve outside the sleeve where the roller to the chain is provided, and an other end is fixedly arranged relative to the vertical plates.

3. The electric lifting type aerial work platform according to claim 2, wherein a number of the vertical plates on the sleeves is two or three, and the vertical plates are parallel to each other, rotating shafts are arranged between the vertical plates, and two of the chains are symmetrically arranged on the rotating shafts.

4. The electric lifting type aerial work platform according to claim 1, wherein: the first push rod is connected to the sleeve located in a middle layer.

5. The electric lifting type aerial work platform according to claim 1, wherein: the workbench comprises a bottom plate and a guard plate extending upward from the bottom plate, the guard plate is provided with a vertical rod, the vertical rod is provided with a cross beam; and the outer sleeve is provided with an upper connecting piece and a lower connecting piece, the lower connecting piece is connected with the guard plate, and the cross beam is set on the upper connecting piece.

6. The electric lifting type aerial work platform according to claim 1, wherein: the workbench comprises a bottom plate, and the bottom plate comprises a lower plate and an upper plate that are capable to move relative to each other; the upper plate is provided with an inner plate, the lower plate is provided with an outer plate; and the outer plate is provided with a limit groove, the inner plate is provided with a limit mechanism; the limit mechanism comprises a base, and a hinge piece rotating relative to the base along a horizontal rotation axis, the hinge piece is provided with a limit piece, and the hinge piece is capable to make the limit piece to move with respect to the limit groove.

7. The electric lifting type aerial work platform according to claim 6, wherein: the inner plate is provided with two frames opposite to each other, and each of the two frames is respectively provided with a door that can be opened by opposite sides, and the door is provided with a manual controller.

8. The electric lifting type aerial work platform according to claim 1, wherein: the column is provided with a trolley at a lower side; the trolley is provided with a second motor, two driving wheels and two walking wheels; the two walking wheels are connected by a connecting rod, and the second motor is provided with an second push rod at output end thereof, the second push rod is hinged with the connecting rod.

9. The electric lifting type aerial work platform according to claim 8, wherein: the trolley is provided with a battery, and the battery is located between a middle position of the first motor and the second motor.
